(19) United States
(12) Patent Application Publication
(10) Pub. No.: US 2014/0182970 A1
(43) Pub. Date: Jul. 3, 2014

(54) EasyUp

(71) Applicant: Keith Roy Williams, Richland, WA (US)

(72) Inventor: Keith Roy Williams, Richland, WA (US)

(21) Appl. No.: 13/733,866

(22) Filed: Jan. 3, 2013

(51) Int. Cl. A61G 7/10; A61G 7/053

(52) U.S. Cl. CPC A61G 7/1038; A61G 7/053
USPC 182/189

(57) ABSTRACT

The EasyUp! is a convenience, safety rehabilitation and medical supply tool for use in the home, elder care, rehabilitation center, hospital or wherever anyone may need assistance in arising from a lying-down to seated, or from seated to a standing position due to injury or illness that may impact either strength or balance. The EasyUp! also assists a person to seat themselves or lie down.

The tool clamps to most heavy “non-rocking” upholstered chairs, couches and beds to provide a stable hand grip that allows an individual to use upper body strength to assist the legs or back and to provide balance as they re-position their body.

### CROSS-REFERENCE TO RELATED APPLICATIONS

N/A—However as an integral part of this Utility Patent, related:
1) Patent protection for the design and concept description of—“The EasyUp!”
2) Patent protection and trademark for term—“The Easy Up! ” and severally for the term “EasyUp!”

### FEDERALLY-SPONSORED RESEARCH

N/A

### SEQUENCE LISTING OR PROGRAM

N/A

### BACKGROUND—FIELD OF INVENTION

There are many reasons why a tool such as “The Easy Up! is needed. Surgeries and abdominal, back, hip or leg injuries may compromise an individual's ability to properly maneuver his or her body. Inner ear damage, stroke or general weakness due to emphysema, Parkinsons, Muscular Dystrophy or other illness may compromise strength and/or balance. Advancing age generally leads to reduced strength and balance, compromising a person's ability to stand or seat themselves, or making it difficult to rise from a lying-down or seated position. The prototype for this invention came from the actual needs of the inventor's 90 year-old mother and a nephew who suffered from a back injury. In both cases, “The EasyUp!” could provide much-needed assistance—very nearly a “hand-up” experience, even when they were alone in the home. This assisted them in maintaining an independent, at-home lifestyle.

“The EasyUp!” is a useful tool for any home containing elderly, or infirm/injured persons whatever the age. It will be an important tool for nursing homes, elder care centers, rehabilitation centers and hospitals. That it is portable and may be moved as needed accentuates its usefulness. That it is inexpensive makes it affordable for the home.

### BACKGROUND—PRIOR ART

The inventor is unaware of any directly or indirectly competing patents or directly-related patents to “The EasyUp!”. There are electric lift chairs to assist people in standing, but not everyone can afford one. Nor are they universally a good idea. In considering rehabilitation and preservation of bodily strength, it is better to try to use one's own bodily resources as much as and for as long as possible. Since lift chairs totally circumvent the body's need for muscle development, not everyone should use them. “The EasyUp!” provides a valuable but relatively inexpensive tool that helps bridge the gap for those that can use general assistance in moving their body either up or down to or from a seated position, but that are not so incapacitated as to require a lift chair. In addition, “The EasyUp!” can be used on a bed or couch to assist a person to or from a prone position as well. It is a versatile, adaptable tool that can be mounted and utilized in a variety of ways, with a person's own home furniture.

### REFERENCE NUMERALS

N/A

### DETAILED DESCRIPTION

“The EasyUp!” is a handgrip mounted on a heavy pipe, rod or tube extending upward from a platform that wedges or clamps to or between the floor and a large piece or stationary furniture (chair, couch or bed). The tool may be made of various materials ranging from wood, composites to metals such as steel or aluminum. It may vary, in component parts or its entirety, in actual size depending upon exact application and need. The inventor's prototype was made of wood and steel pipe. The attached drawings reflect a metal structure (aluminum preferred, but steel would work).

There are two basic forms of “The EasyUp!”. One has a platform and upright rod that is stabilized by an L-shaped support that is driven upward against the furniture by threaded rods. The design provides the most stable and adaptable format. The second version is a platform and upright rod stabilized against the furniture by a rubber wedge which is driven as tight under the furniture as possible. This is not the best format as it may shift and loosen and will tend to damage upholstery fabrics and wood surfaces.

### DRAWINGS—FIGURES

### Figures (Description): Image of “The EasyUp!”

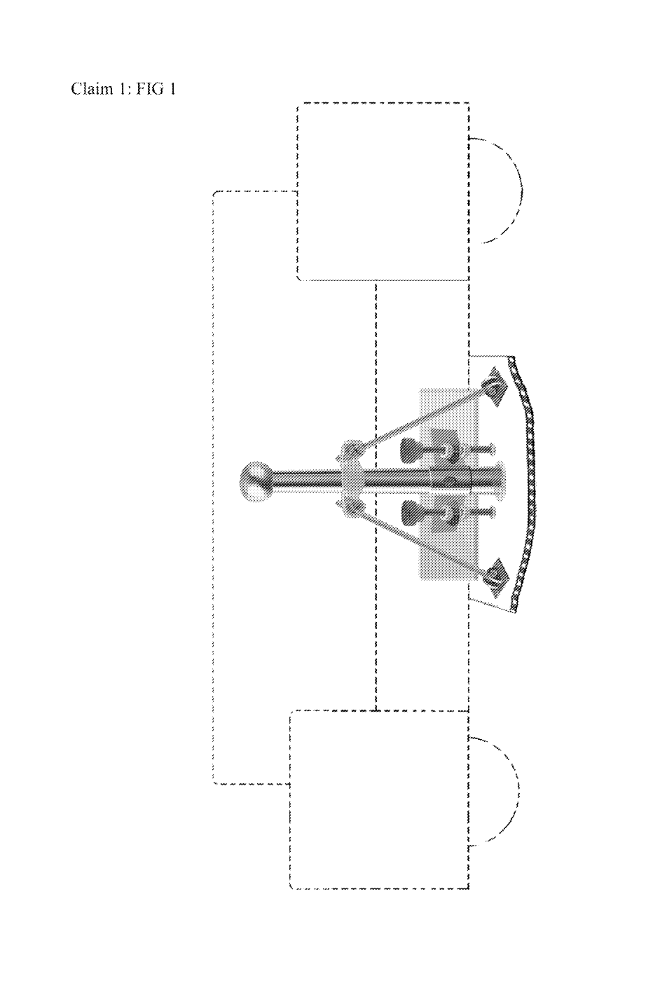

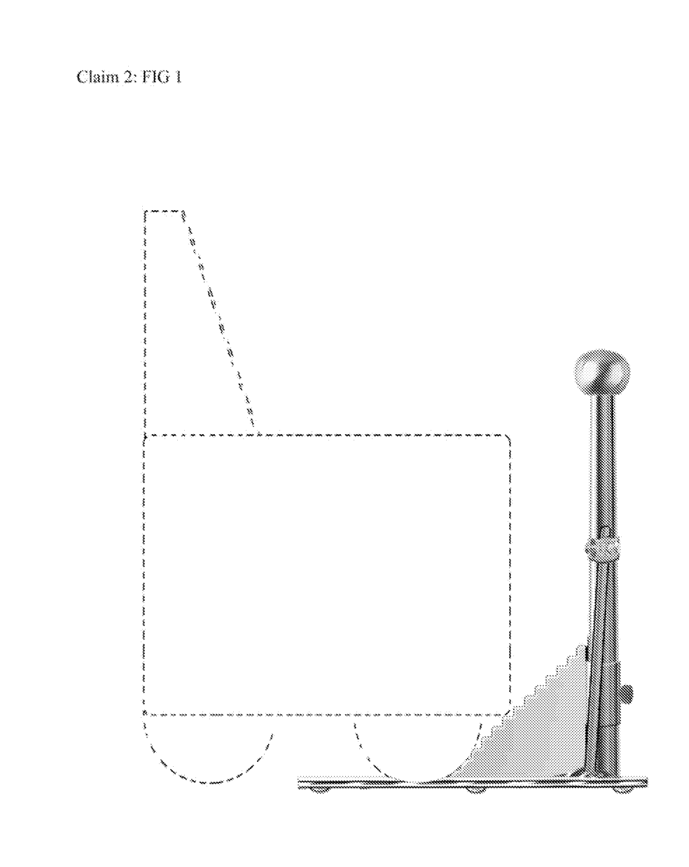

Claim 1: FIG. 1 “The EasyUp!” Front View-In Place with Couch;

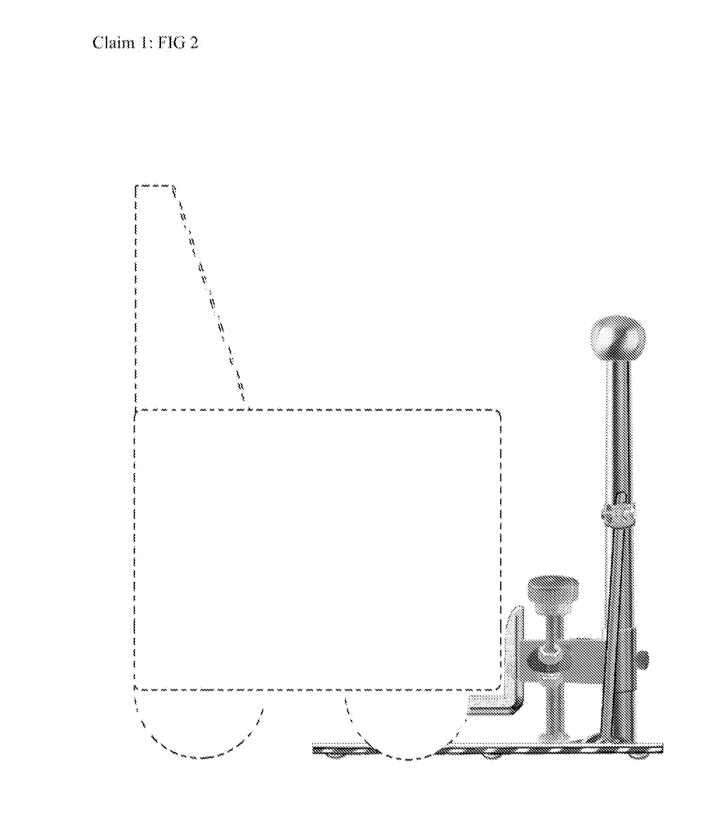

FIG. 2 “The EasyUp!” Side View-In Place with Chair/Couch;

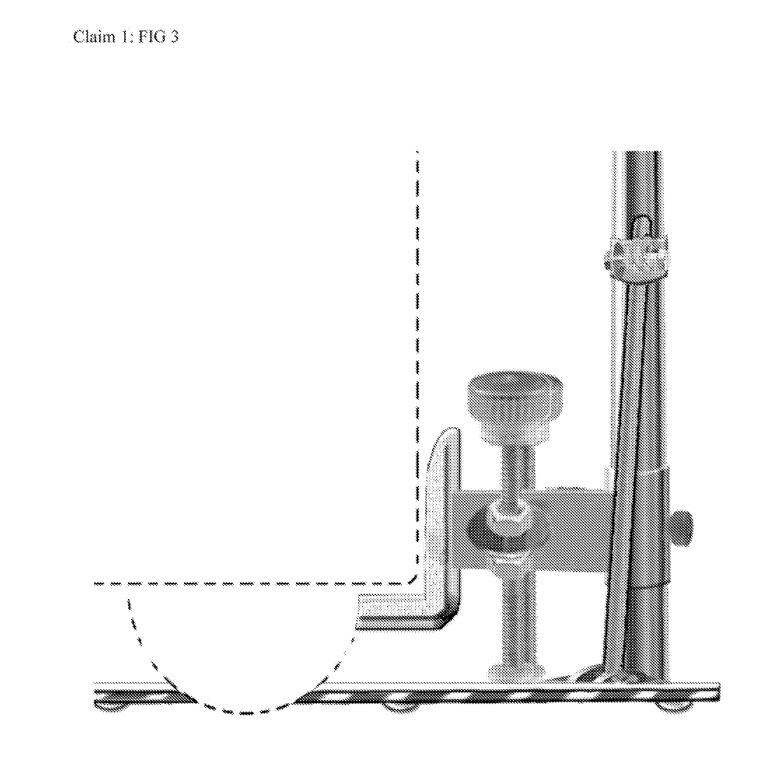

FIG. 3 “The EasyUp!” Expanded Side View-In Place w/Chair or Couch;

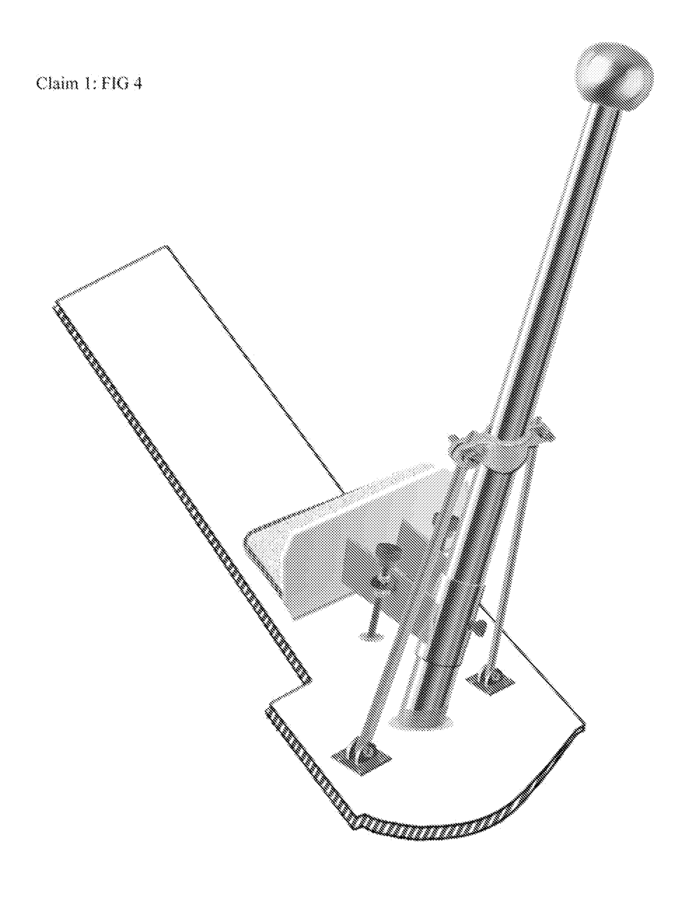

FIG. 4 “The EasyUp!” Oblique Front View;

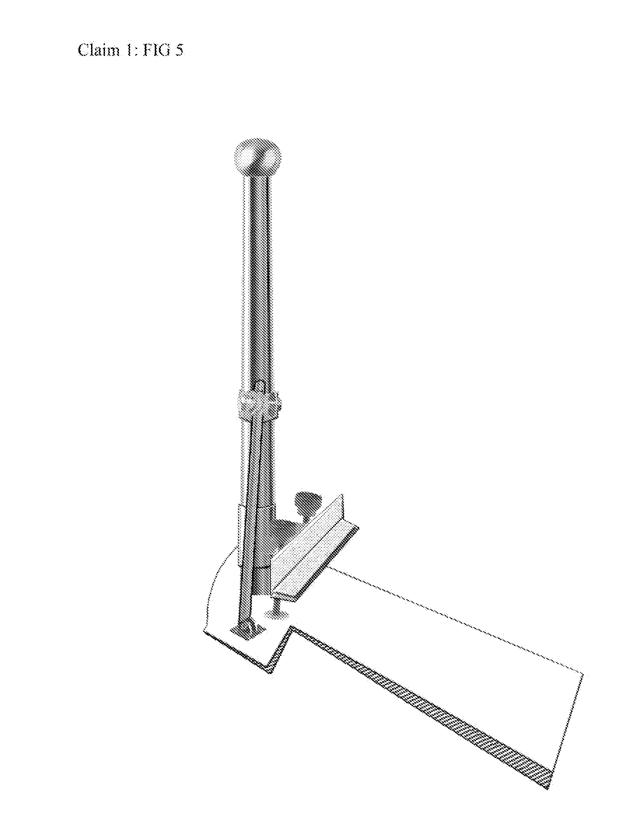

FIG. 5 “The EasyUp!” Oblique Side View.

Claim 2: FIG. 1. Image of “The EasyUp!” (as in Claim 1) with a rubber wedge rather than the adjustable clamps.

### DESCRIPTIVE SUMMARY

“The EasyUp!” is a home convenience, safety and medical supply tool for use in the home, elder care or rehabilitation center, or wherever anyone may need assistance in arising from a lying-down to seated, or from seated to a standing position due to injury or illness that may impact either strength or balance. “The EasyUp!” also assists a person to seat themselves or lie down.

The tool clamps to most heavy “non-rocking” upholstered chairs, couches and beds to provide a stable hand grip that allows an individual to use upper body strength to assist the legs or back and to provide balance as they re-position their body.

“The EasyUp!” is a simple, portable cost-effective tool that essentially allows the elderly and/or persons who have undergone surgeries, illness or injury to retain their independence in their home. It also provides a useful tool for medical professionals in the care of their patients.

1. “The EasyUp!”. The inventor claims the rights to a tool which may vary in component materials and sizes, but is essentially a handgrip mounted on a heavy pipe, rod or tube extending upward from a platform that wedges or clamps to or between the floor and a large piece or stationary furniture (chair, couch or bed). The tool may be made of various materials ranging from wood, composites to metals such as steel or aluminum. It may vary, in component parts or its entirety, in actual size depending upon exact application and need. Holes are provided through the platform in the rare event someone may wish to mount the tool permanently to the floor via screws or bolts.
As drawn for illustrative purposes only, the base platform sits on 10 rubber feet and may be solid, ribbed or reinforced aluminum or steel. A solid metal rod or pipe is threaded upright into this base. A sleeve slides up and down from the floor to perhaps 10 inches up the upright. Attached to this sleeve are the padded “L-shaped” supports that are driven upward against the front/underside of the furniture by two long, threaded rods with knobs or knurled handles. There are two locking nuts that set each of these threaded rods once the padded supports are tight in position. A set screw or locking screw is also in the front of this sleeve. Further up the upright post is a pipe clamp that serves as the point of attachment for two struts which angle down, one on each side, to the outer edge of the base platform. At the top of the upright rod is a 2.5 to 3 inch grip, shaped as a ball. The user grasps this grip from whichever direction needed as he or she pulls him/herself into position.

2. Device as recited in claim 1, wherein the adjustable clamping mechanisms are missing. Instead there is simply a large rubber wedge, shaped like a triangular truck chock, affixed between the upright post and the furniture. The user simply sets the platform and chock firmly into place between the furniture and the floor. This will provide a fair grip and temporary hold, but is not as desirable and useful as described in claim one. It may also damage the finish and upholstery on fine furniture more than will the device as described in claim 1. Its advantage is lower production (and purchase) costs and ease of use. It can be quickly and easily moved from one place to another with a minimum of effort.

3. The prototype unit. This is simply a plywood platform with steel waterpipe serving as the upright gripping station. It could vary in size and weight of construction.
While the invention has been specifically described as claims 1-3 in connection with certain specific embodiments thereof, it is to be understood that this is by way of illustration and not of limitation, and the scope of the claims should be broadly construed.
